(19) United States
(12) Patent Application Publication
(10) Pub. No.: US 2025/0235898 A1
(43) Pub. Date: Jul. 24, 2025

(54) Pump for Sludge Removal Apparatus

(71) Applicant: Barrnon Ltd., Appleby-in-Westmorland (GB)

(72) Inventor: Andrew Fraser BARR, Cumbria (GB)

(21) Appl. No.: 19/029,385

(22) Filed: Jan. 17, 2025

(30) Foreign Application Priority Data
Jan. 19, 2024 (GB) GB 2400738.7

(51) Int. Cl. B08B 1/40; B08B 1/16; B08B 1/30

(52) U.S. Cl. CPC B08B 1/40; B08B 1/165; B08B 1/30

(57) ABSTRACT

A pump for sludge removal apparatus, a method of operating the pump, and a sludge removal apparatus including the pump are provided. The pump includes a pump housing having a pumping inlet at a front end and a pumping outlet at a rear end defining a rearwards direction; and a pumping nozzle positioned within the housing and oriented to direct fluid along the housing towards the rear end. The housing includes an inlet portion that decreases in cross-section from a front end to a rear end optionally a throat portion having a constant cross-sectional area positioned immediately adjacent the rear end of the inlet portion and an outlet portion that increases in cross-section from a front end to a rear end with the front end positioned immediately adjacent the throat portion if present, or immediately adjacent the rear end of the inlet portion if a throat portion is not present; wherein the pumping nozzle is positioned within the housing in front of the inlet portion of the pump housing. The pump can be positioned adjacent a rear end of a sludge removal apparatus and act to pump sludge away from the sludge removal apparatus.

### CROSS-REFERENCE TO RELATED APPLICATIONS

The present application is based upon and claims the right of priority to GB Patent Application No. 2400738.7, filed Jan. 19, 2024, the disclosure of which is hereby incorporated by reference herein in its entirety for all purposes.

### FIELD OF THE INVENTION

The invention relates to the removal of sludge from underwater deposits.

### BACKGROUND TO THE INVENTION

Sludge can build up over time on the floors of artificial containers for water such as tanks or ponds or on the floors of natural bodies of water such as lakes and oceans.

Removal of the sludge may be desirable to increase the volume or flow of water, to remove pollutants contained in the sludge, to collect the sludge for use as a resource or for other reasons.

The source of the sludge may be natural, e.g. from settlement of particles suspended in the water, or may be artificial, e.g. as a result of mining or drilling. It may include particles of a well-defined size or of a range of sizes. The size or range of sizes may vary substantially between different deposits. The sludge may contain varying proportions of water within its structure. As a result of the pattern of deposition, the sludge may be uniform or stratified. As a result of physical or chemical processes following deposition, the particles may be bonded together in a consolidated mass or they may be held together only by gravity. For the purposes of this specification, the term “sludge” should also be taken to include dense liquids and semi-solids such as wax that are not particulate in nature but have similar properties and, in particular, are susceptible to fluidization by the use of pressurized water.

One example of sludge that requires removal is an accumulation on the floors of the ponds in which nuclear waste is stored. The ponds are artificially constructed so the floors can be assumed to be flat and even but the presence of larger items dropped into the ponds cannot be ruled out, Because such sludge is radioactive, it requires efficient collection and careful disposal, and this must be achieved remotely from the presence of a human operator. Such sludge tends to have built up slowly over a long period and is therefore stratified and may be relatively strongly bonded.

GB2515890 discloses a blade cutter device for the removal of accumulated sludge, with particular utility for removing radioactive sludge. The blade cutter has a housing having a front and a rear, an outlet through which sludge can be removed from the rear of the housing, a blade on the housing having a cutting edge that points forwards and a surface to the rear of the cutting edge that faces the interior of the housing and one or more nozzles that direct jets of water onto the blade surface to fluidize sludge cut by the cutting edge. This device operates by being pushed forwards such that the cutting edge cuts into the surface of the sludge to separate a layer of sludge and direct it into the interior of the housing. The jets of water fluidize the water and carry it towards the rear of the housing. A second row of jets may be arranged to further carry the fluidized sludge towards the rear of the housing. A jet pump is provided at or near the rear of the housing to remove water and the fluidized sludge from the rear of the housing and deliver it to an outer for further processing external to the apparatus.

FIGS. 1 and 2 of the present application, show an embodiment of a prior art blade cutter from GB 2525890 wherein the forward and rearward directions are typically vertical, the apparatus being lowered from a crane under its own weight or actively pushed down into the bulk sludge deposit. Such embodiments may be provided through a vertical pipeline down into a sludge deposit. The diameter of such vertical pipelines may be 4 inches (10.2 cm) or less. Therefore, for such embodiments it is preferable that all components, including any pump can fit through a pipeline of this diameter.

During operation of the blade cutter of FIGS. 1 and 2 it has been found to be difficult to balance the speed of the jet pump with the rate of removal of sludge by the cutting blade. There have also been issues with providing mechanical pumps in environments such as radioactive sludge, these quickly degrade the operation of the pumps. As a result, there is a need for an improved pump for sludge removal apparatus, for example apparatus that require the removal of fluidized sludge that may be radioactive.

### SUMMARY OF THE INVENTION

The present invention provides a pump for a sludge removal apparatus, a method of operating the pump and a sludge removal apparatus including the pump.

A pump according to the present invention includes:
a pump housing having a pumping inlet at a front end and a pumping outlet at a rear end defining a rearwards direction; and
a pumping nozzle positioned within the housing and oriented to direct fluid along the housing towards the rear end; wherein
the housing includes:
an inlet portion that decreases in cross-section from a front end to a rear end;
optionally a throat portion having a constant cross-sectional area positioned immediately adjacent the rear end of the inlet portion; and
an outlet portion that increases in cross-section from a front end to a rear end with the front end positioned immediately adjacent the throat portion if present, or immediately adjacent the rear end of the inlet portion if a throat portion is not present;
wherein the pumping nozzle is positioned within the housing in front of the inlet portion of the pump housing.

The pump of the present invention is advantageous in that it is a simple construction that can provide powerful suction for a blade cutter capable of pumping fluidized sludge significant vertical distances. Further a pump according to the present invention may have no moving parts and is suitable for use in hostile environments such as where radioactive sludge is located. Further, the pump may be substantially cylindrical and have a narrow diameter such that it can fit down narrow pipes to reach environments where sludge is located.

In embodiments of the invention the housing may have a substantially circular internal cross-section along its length. Embodiments may be substantially cylindrical and be formed to be easily slid down lengths of pipe. An embodiment of the present invention may be sized and shaped to be able to be moved along a standard sized 4 inch (10.2 cm) diameter pipeline.

The outlet portion of the pump may have an internal wall that is at a constant angle to a longitudinal axis of the housing. That angle may be relatively shallow such that the outlet portion gradually increases in cross-section along its longitudinal length towards the rear end. The internal wall of the outlet portion may be at an angle between 2° and 10°, between 4° and 8°, or between 5° and 7° relative to the longitudinal axis of the housing. Currently an angle of about 6° is preferred.

The inlet portion of the pump may have an internal wall that is at a constant angle to a longitudinal axis of the housing. That angle may be relatively steep such that the inlet portion quickly reduces in cross-section along its longitudinal length towards the rear end. The internal wall of the inlet portion may be at an angle between 15° and 75°, between 30° and 60°, or between 45° and 60° relative to the longitudinal axis of the housing. Currently an angle of about 60° is preferred.

The pumping nozzle may have any size and shape considered appropriate to the particular embodiment of the invention. In embodiments of the invention the pumping nozzle may have a diameter between 1 mm and 15 mm, between 1 mm and 10 mm or between 1 mm and 5 mm. Currently a nozzle diameter of 3 mm is preferred.

The pumping nozzle may be positioned at or at a distance from the inlet portion. Generally the pumping nozzle should be positioned relatively close to the inlet portion, for example between 0 mm and 60 mm, between 0 mm and 40 mm, between 0 mm and 20 mm, or between 0 mm and 10 mm from the inlet portion. Currently it is preferred that the nozzle is 2 mm from the inlet portion.

The throat portion of the present invention may have any suitable length. In embodiments of the invention the throat portion has a longitudinal length of between 0 mm and 50 mm, between 0 and 30 mm, between 0 mm and 20 mm, or between 0 and 10 mm. Currently it is preferred that the throat portion is 5 mm long.

The present invention also provides a method of operating a pump according to any of claims 1 to 8, wherein a fluid is pumped through the pumping nozzle. It will be generally preferred that the fluid is water although any other suitable pumping fluid may be used. The fluid will generally be pressurised and provided from a remote pump along a pipeline that terminates at the pumping nozzle. A remote pump may be at some distance from the pump itself and may be any suitable pump for providing pressurised fluid.

Water or any other fluid may be provided to the pumping nozzle at any appropriate flow apparent to the person skilled in the art. Fluid may be provided at a flow rate between 40 litres per minute and 60 litres per minute, or between 40 litres per minute and 50 litres per minute. For example, fluid may be provided at about 47 litres per minute.

Water or any other fluid may be provided to the pumping nozzle at any appropriate pressure apparent to the person skilled in the art. Fluid may be provided at a pressure of between 100 bar (10 MPa) and 150 bar (15 MPa) or between 110 bar (11 MPa) and 140 bar (14 MPa) or between 120 bar (12 MPa) and 130 bar (13 MPa). For example, fluid may be provided at a pressure of about 123 bar (12.3 MPa).

The present invention also provides a sludge removal apparatus includes:
a pump according to the present invention as described above and defined in the claims;
a blade cutter apparatus, wherein the blade cutter includes:
a blade cutter housing having a front and a rear;
an outlet through which sludge can be removed from the rear of the blade cutter housing;
a first blade on the blade cutter housing, the first blade having a cutting edge that points forwards and a first blade surface to the rear of the cutting edge that faces the interior of the blade cutter housing; and
at least one first nozzle positioned and oriented to direct a jet of water onto the blade surface, the jet having a component of motion in the rearward direction relative to the blade surface.

For example, the sludge removal apparatus may include a blade cutter apparatus according to the prior art as described above and a pump according to any of claims 1 to 9 of the present application.

The pump may be directly attached to the outlet of the blade cutter apparatus or the pump may at a distance from the outlet of the blade cutter apparatus and directly connected thereto by a suitable conduit such as a pipe or other body in which fluid can be contained. For example, the pump may be between 0 mm and 3000 mm, between 0 mm and 2000 mm, or between 0 mm and 1000 mm from the outlet of the blade cutter apparatus. In embodiments of the invention the pump may be at a distance of 500 mm from the outlet of the pump.

In embodiments of the invention the or each nozzle of the blade cutter apparatus may be supplied with fluid from the same source as the pumping nozzle of the pump. Any suitable pipe or conduit may be provided for providing fluid to the nozzle of the blade cutter apparatus.

Further features and advantages of the present invention will be apparent from the preferred embodiment shown in the Figures and described below. Unless otherwise indicated by the claims or by context, any feature of the embodiment of the invention shown in the Figures may be included in an embodiment of the invention independently from any other feature.

### DRAWINGS

FIG. 1 is a side elevation of an embodiment of a blade cutter apparatus according to the prior art;

FIG. 2 is a cross-section on line B-B of the apparatus of FIG. 1;

FIG. 3 is a side elevation of a pump according to the present invention; and

FIG. 4 is a cross-section on line A-A of the pump of FIG. 3.

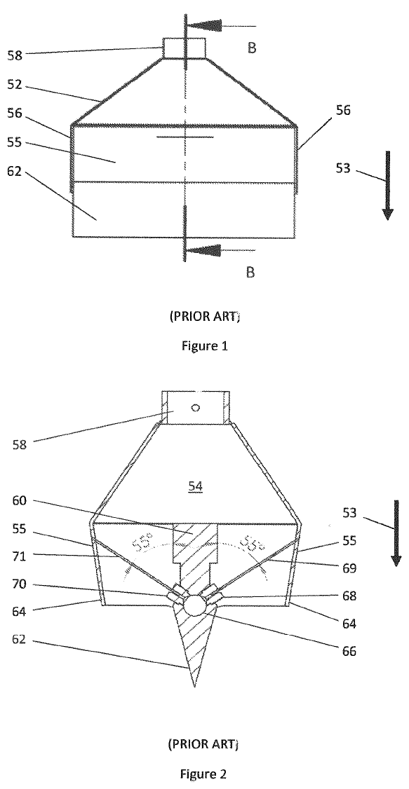

FIGS. 1 and 2 illustrate an embodiment of a blade cutter apparatus according to the prior art, which is an apparatus for removing a sludge from deep deposit that may not be stratified and may not lie on a level floor.

The apparatus includes a housing 52, which defines a forward direction (indicated by an arrow 53) and an opposite rearward direction. In this embodiment the forward and rearward directions are typically vertical, the apparatus being lowered from a crane under its own weight or actively pushed down into the bulk sludge deposit, but if the apparatus is pushed it may in fact be used in any orientation, Reciprocal movements may be applied to the apparatus or vibration at up to ultrasonic frequencies may be used to assist the passage of the blades through the sludge.

The housing 52 includes a collection chamber surrounded by side walls 55 and end walls 56 but generally open in the forward direction. The collection chamber 54 tapers towards a port 58 at the rear end, from which water and fluidized sludge can be removed by a pump (not shown) for further processing externally to the apparatus. A grid (not shown) of suitable spacing may be provided to prevent objects greater than a certain size from entering the collection chamber 54 through the opening.

A central boss 60 extends across the collection chamber 54 between the end walls 56. A blade 62 projects forwards from the boss 60 through the opening of the collection chamber 54. The blade 62 may be integral with the boss 60 or it may be a separate component mounted on the boss 60, which can optionally be replaced when it has become worn.

As the apparatus moves forwards, the forward blade 62 slices into the bulk sludge, deflecting it to each side of the blade 62 and into the opening of the collection chamber 54. The front edges of the side walls 55 serve as cutting blades 64 that also penetrate the sludge and guide parts of it into the chamber 54, If the sludge is sufficiently soft, the cutting blades 64 need not be particularly sharp. As shown in FIG. 6, it is preferred that the cutting blades 64 should converge slightly in the forward direction to promote a good seal against the undisturbed sludge. This helps to prevent the escape of fluidized sludge that is circulating in the collection chamber. An inlet (not shown) delivers water at high pressure from an external source to a manifold 66 that extends along the central boss 60. A first set of nozzles 68 is arranged along one side of the manifold 66 to direct a first row of jets 69 of the pressurized water onto the surface of one cutting blade 64 (i.e. the side wall 55). A second set of nozzles 70 is arranged along the other side of the manifold 66 to direct a second row of jets of the pressurized water onto the surface of the opposite cutting blade 64 (i.e. the other side wall 55). The apparatus is therefore mirror-symmetrical about its centre line, although it is possible for the symmetry to be slightly broken by alternating the first and second nozzles 68, 70 along the length of the manifold 8.

The jets 69, 71 preferably fan out from the nozzles 68, 70 to form an unbroken line where they impinge on the side walls 55. The angle of incidence of the jets 69, 71 on the side walls 55 may vary substantially, provided that it has a component of motion in the rearward direction relative to the surface of the side walls in order that the jets rebounding from the side walls should convey the fluidized sludge towards the rear of the collection chamber.

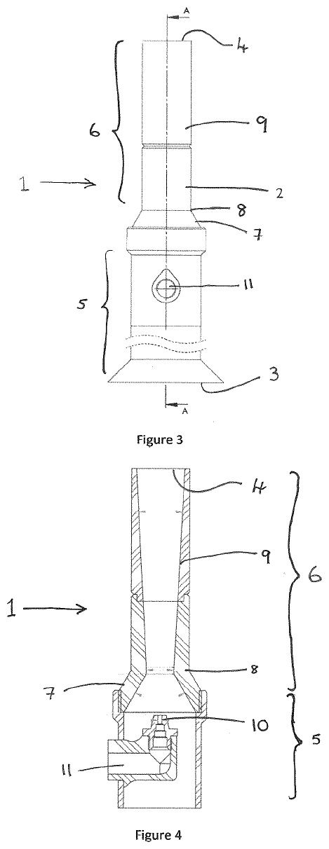

FIGS. 3 and 4 illustrate an embodiment of a pump 1 according to the present invention.

The pump 1 has a substantially cylindrical housing 2 extending from a front end 3 to a pumping outlet 4 at a rear end. The housing 2 generally defines a front part 5 and a pumping part 6, positioned rearwards of the front part. The pumping part 6 of the housing includes a relatively short inlet portion 7 that rapidly decreases in internal cross-sectional area from a front end to a rear end, a throat portion 8 of constant internal cross-sectional area, and a relatively long outlet portion 9 that gradually increases in cross-sectional area from a front end to the pumping outlet 4. The cross-section of the housing 2 is substantially circular along its entire length.

A pumping nozzle 10 is positioned centrally within the front part 5 of the housing before the pumping part 6 and is positioned and oriented centrally within the housing to push water along a longitudinal axis of the pump (along line A-A). Water is supplied to the pumping nozzle 10 by a supply pipe 11 formed through the wall of the front part 5 of the housing and connected to an external pressurised supply of water (not shown). During operation water is pumped into the pump 1 through the pumping nozzle 10 towards the pumping outlet along the longitudinal axis of the pump 1. The shape of the pumping part 6 with a rapidly narrowing inlet portion and a gradually broadening outlet portion acts as a pump to draw fluid up the pump 1 from the front end 3 to the pumping outlet 4.

The inlet portion 7 has an internal wall angled at 60° to the longitudinal axis of the pump 1 but embodiments of the invention may have the wall angled anywhere between 15° and 75°. The outlet portion 9 has an internal wall angled at 6° to the longitudinal axis of the pump 1 but embodiments of the invention may have the wall angled anywhere between 2° and 10°. The internal diameter of the throat portion 8 is 20 mm and the throat portion has a length of 5 mm. The pumping nozzle 10 has a diameter of 3 mm and the pumping nozzle 10 is positioned 2 mm from the inlet portion.

It is to be understood that the pump 1 of the present invention can be fitted to a blade cutter, such as that shown in FIGS. 1 and 2, to form a blade cutter according to the present invention. In particular, the pump 1 of FIGS. 3 and 4 can be mounted at the port 58 of the blade cutter of FIGS. 1 and 2 and will act as a pump to draw fluid out of the blade cutter. In embodiments the first and second nozzles 68, 70, may be supplied form the same water supply as the pump nozzle 10. The pump 1 may be located at a distance from the blade cutter. In embodiments of the invention the pump may be anywhere up to 3000 mm from the blade cutter.

Importantly the pump 1 of the present invention has no moving parts and can be formed to fit down pipes with small diameters, such as the 4 inch (10.2 cm) diameter pipes commonly used to access radioactive sludge. This makes it practical to use and the lack of moving parts can extend the lifespan of the pump as compared to other pumps. Further, a single pressurised water supply can be used to feed both the pumping nozzle 10 of the pump and the first and second nozzles 68, 70 of the blade cutter.

1. A pump for a sludge removal apparatus, comprising:
a pump housing having a pumping inlet at a front end and a pumping outlet at a rear end defining a rearwards direction; and
a pumping nozzle positioned within the housing and oriented to direct fluid along the housing towards the rear end; wherein
the housing comprises:
an inlet portion that decreases in cross-section from a front end to a rear end;
an outlet portion that increases in cross-section from a front end to a rear end with the front end positioned immediately adjacent a throat portion if present, or immediately adjacent the rear end of the inlet portion if the throat portion is not present;
wherein the pumping nozzle is positioned within the housing in front of the inlet portion of the pump housing.

2. The pump according to claim 1, wherein the housing is substantially circular in cross-section.

3. The pump according to claim 1, wherein the pump is sized and shaped to be able to positioned within a 4 inch (10.2 cm) diameter pipeline.

4. The pump according to claim 1, wherein an internal wall of the outlet portion is at an angle between 2° and 10° relative to a longitudinal axis of the housing.

5. The pump according to claim 1, wherein an internal wall of the inlet portion is at an angle between 15° and 75° relative to a longitudinal axis of the housing.

6. The pump according to claim 1, wherein the pumping nozzle has a diameter between 1 mm and 15 mm.

7. The pump according to claim 1, wherein the pumping nozzle is positioned between 0 mm and 60 mm from the front end of the inlet portion.

8. The pump according to claim 1, wherein the throat portion has a longitudinal length of between 0 mm and 50 mm.

9. A method of operating a pump according to claim 1, wherein water is pumped through the pumping nozzle to operate the pump.

10. The method according to claim 9, wherein the water is pumped through the pumping nozzle at a flow rate between 40 litres per minute and 60 litres per minute.

11. The method according to claim 9, wherein water is pumped through the pumping nozzle at a pressure of between 100 bar (10 MPa) and 150 bar (15 MPa).

12. A sludge removal apparatus, comprising:
a pump according to claim 1; and
a blade cutter apparatus, wherein the blade cutter comprises:
a blade cutter housing having a front and a rear;
an outlet through which sludge can be removed from the rear of the blade cutter housing;
a first blade on the blade cutter housing, the first blade having a cutting edge that points forwards and a first blade surface to the rear of the cutting edge that faces the interior of the blade cutter housing; and
at least one first nozzle positioned and oriented to direct a jet of water onto the blade surface, the jet having a component of motion in the rearward direction relative to the blade surface.

13. The sludge removal apparatus according to claim 12, wherein the pump is directly attached to the outlet.

14. The sludge removal apparatus according to claim 12, wherein the at least one first nozzle is supplied with water from the inlet pipe of the pump.

15. The sludge removal apparatus according to claim 12, wherein the pump is between 0 mm and 3000 mm from the outlet of the blade cutter.
